(19) United States
(12) Patent Application Publication
(10) Pub. No.: US 2016/0071499 A1
(43) Pub. Date: Mar. 10, 2016

(54) D-PICK

(71) Applicant: Stephen Robert WARDWELL, Mission Viejo, CA (US)

(72) Inventor: Stephen Robert WARDWELL, Mission Viejo, CA (US)

(21) Appl. No.: 14/477,796

(22) Filed: Sep. 4, 2014

(51) Int. Cl. G10D 3/16

(52) U.S. Cl. CPC G10D 3/163

(57) ABSTRACT

A stringed instrument pick made with two lobes designed into the plucking end. The Dual lobe when strumming provides double the plucking sound of each string when strummed.

### REFERENCES CITED

US PATENT DOCUMENTS

| | | |
|---|---|---|
| 6,815,597 | October 2001 | Bosley, M |
| 8,395,038 | January 2011 | Smith, J |
| 7,683,245 | November 2004 | Judd, B |
| 8,227,675 | September 2010 | Koelzer, D |
| 4,711,150 | December 1984 | Hyduck, S |
| 5,509,341 | December 1994 | Dunlop, J |
| 7,786,362 | August 2009 | Whitstine, F |
| 5,261,307 | July 1992 | Domanski, J |
| 8,664,498 | April 2012 | Lenemen, M |
| 7,956,264 | August 2009 | Risolia, J |
| 7,786,362 | April 2006 | Whetstine, F |
| 7,461,768 | May 2006 | Newmaster, J |
| 7,238,869 | May 2006 | Kleckzka, D |
| 7,067,729 | December 2001 | Leong, W |
| 6,417,431 | December 2000 | Wilkinson, C |
| 6,127,613 | November 1999 | Hansel, D |
| 5,594,189 | May 1995 | Latteri, K |

### BACKGROUND

This invention relates to stringed instruments and particularly to picks used by guitarists and the like. The musician chooses a pick according to the style and technique of playing. Accordingly, conventional picks for stringed instruments are made in various thicknesses and of different materials such as wood, bone, stone, plastic and metals and are generally a triangular shape with rounded corners.

Picking activates the string producing sound. It is done with the pick normal to the surface of the string plane on the instrument and each pluck starts the string resonating. With the D-Pick held with the lobes parallel the strings, each pluck will initiate the string reverberating once. When the D-Pick is clocked and strummed across a string, it will pluck the string with the leading lobe, followed by another pluck as the trailing lobe strums the string. The duration between leading and trailing lobes can be delayed by the amount of clocking and speed of the strum.

### FIGURES

FIG. 1 is a front view of the stringed instrument D-Pick

FIG. 2 is a side view of the D-Pick

FIG. 3 is an isometric view of the D-Pick

FIG. 4 is a view of the D-Pick's application across stings

FIG. 5 shows relative sound wave produced by the D-Pick

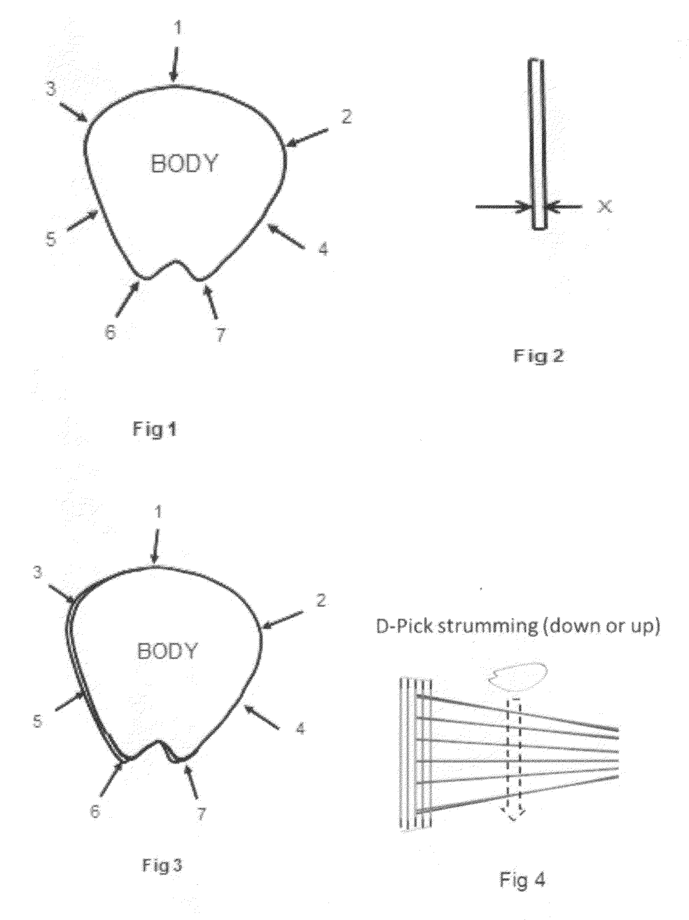

Referring to FIGS. 1,2 & 3—the D-Pick is for playing stringed instruments, guitars, banjos, mandolins, etc. The pick is of usual configuration, comprised of a body of generally thin nylon material in the shape of an acute triangle with convex curved top and side edges 1, 2, 3, 4 & 5.

It is the lower most corners 6 & 7 that are the picking edges. The body is approximately 1″ wide at the top shoulders and 1.1″ long from picking edges to top edge 1. The thickness (x) varies as with other traditional picks (0.017-0.035″). In the practice of using the pick to play an instrument, the upper portion of the flat body is gripped between the thumb and index finger, thereby exposing the lower picking portion and picking edges.

FIG. 4 shows the D-Pick's use on a stringed instrument. The direction of strumming or strings activated are the musician/players choice.

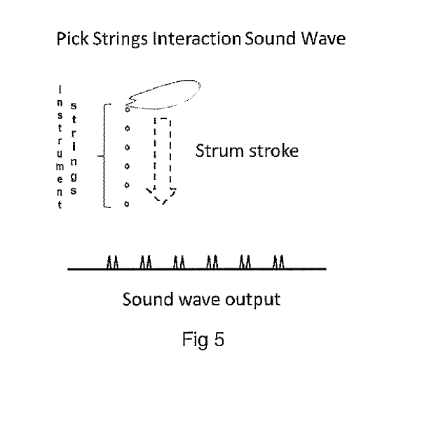

FIG. 5 demonstrates the sound wave output when the D-Pick is strummed across strings. Each string will be picked 2 times as the lobes 6 & 7 make contact during a strum.

The duration between the 2 plucks can be altered by rotating the pick in the players hand; in conjunction with the speed the pick is being strummed.

### Functionality:

The pick is the same basic size as standard guitar picks—with single lobe (plucking point) and used in the same manner, by strumming the pick normal to the instrument strings.

The instrument's interaction with the D-Pick and user's approach to strumming produce the unique sound of this invention.

What is claimed is:

1. A stringed instrument pick which is made up of:
an acute triangular shape body, with convex curved sides and radiused corners;
the base width is approximately 1″ wide and approximately 1.1″ long; and
the thicknesses of pick is variable (0.017-0.035″), with the apex of the two sides forms the picking end, which has two lobes.
